(19) United States
(12) Patent Application Publication
(10) Pub. No.: US 2012/0089355 A1
(43) Pub. Date: Apr. 12, 2012

(54) FAN TESTING SYSTEM

(75) Inventors: LING-YU XIE, Shenzhen City (CN); XING-PING XIE, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/086,243

(22) Filed: Apr. 13, 2011

(30) Foreign Application Priority Data
Oct. 11, 2010 (CN) 201010503129.6

(51) Int. Cl. G06F 19/00

(52) U.S. Cl. 702/64

(57) ABSTRACT

A fan testing system includes a control device testing a fan, and a micro controller outputs pulse control signals to the fan. The control device stores a number of normal rotational voltage and rotational current values under different rotational speeds. The fan adjusts its rotational speed according to the pulse control signals, and outputs rotational speed signals to the micro controller. The micro controller collects rotational voltage signals and rotational current signals of the fan under different rotational speeds, and determines rotational speeds, rotational voltages, and rotational currents of the fan. The control device compares the rotational speeds, rotational voltages and rotational currents from the micro controller with the number of normal rotational voltage and rotational current values, and outputs a test complete signal to the micro controller when the fan rotates under the plurality of normal rotational voltage and rotational current values.

### BACKGROUND

1. Technical Field

The disclosure generally relates to a testing system, and especially to a system for testing a fan in a computer.

2. Description of Related Art

With the development of the computer industry, operating frequencies of most components in computer systems have increased, and the heat generated by these components has increased as well. If the heat is not removed in a timely fashion, the computer system may overheat and the system could be damaged or destroyed. Usually, a fan is used for preventing the temperature in the computer system from becoming too high. Generally, the faster the fan rotates, the faster it can remove heat. These fans need to be tested before being used in computer systems. In general, testers need to test parameters of the fans such as rotational speed, rated voltage, and rated current. However, a typical testing method requires engineers to operate a special test apparatus and record the output voltages of the fan, which is inefficient and expensive.

Therefore there is a need for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a fan testing system, the fan testing system includes a fan, a test control apparatus and a control device.

FIG. 2 is a circuit view of the micro controller, the switch module, the indication module, and the alarm module of the embodiment shown in FIG. 1.

FIG. 3 is a circuit view of the power supply module and the conversion module of the embodiments shown in FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or Assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

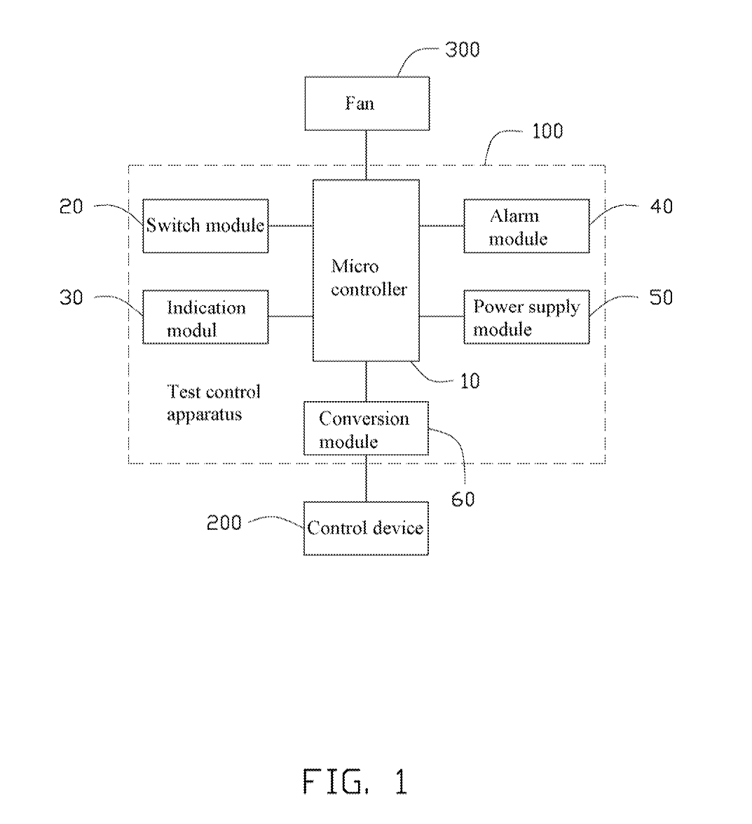

Referring to FIG. 1, an embodiment of a fan testing system includes a test control apparatus 100, a control device 200, and a fan 300. The test control apparatus 100 includes a micro controller 10, a switch module 20, an indication module 30, an alarm module 40, a power supply module 50, and a conversion module 60. The control device 200 controls the micro controller 10 to output pulse control signals to the fan 300. The fan 300 adjusts its rotational speed according to the pulse control signals, and outputs rotational speed signals to the micro controller 10. The micro controller 10 collects rotational voltage signals and rotational current signals of the fan 300 under different rotational speeds, and determines rotational speeds, rotational voltages, and rotational currents of the fan 300. The micro controller 10 outputs the rotational speeds, rotational voltages, and rotational currents to the control device 200 via the conversion module 60. The control device 200 stores a plurality of normal rotational voltage and rotational current values under different rotational speeds. The control device 200 compares the rotational speeds, rotational voltages and rotational currents from the micro controller 10 with the plurality of normal rotational voltage and rotational current values, and outputs a test completed signal to the micro controller 10. The micro controller 10 outputs an indication signal to the indication module 30 when it receives the test completed signal. The indication module 30 emits light to indicate that the fan 300 is rotating under a normal rotational speed when it receives the indication signal.

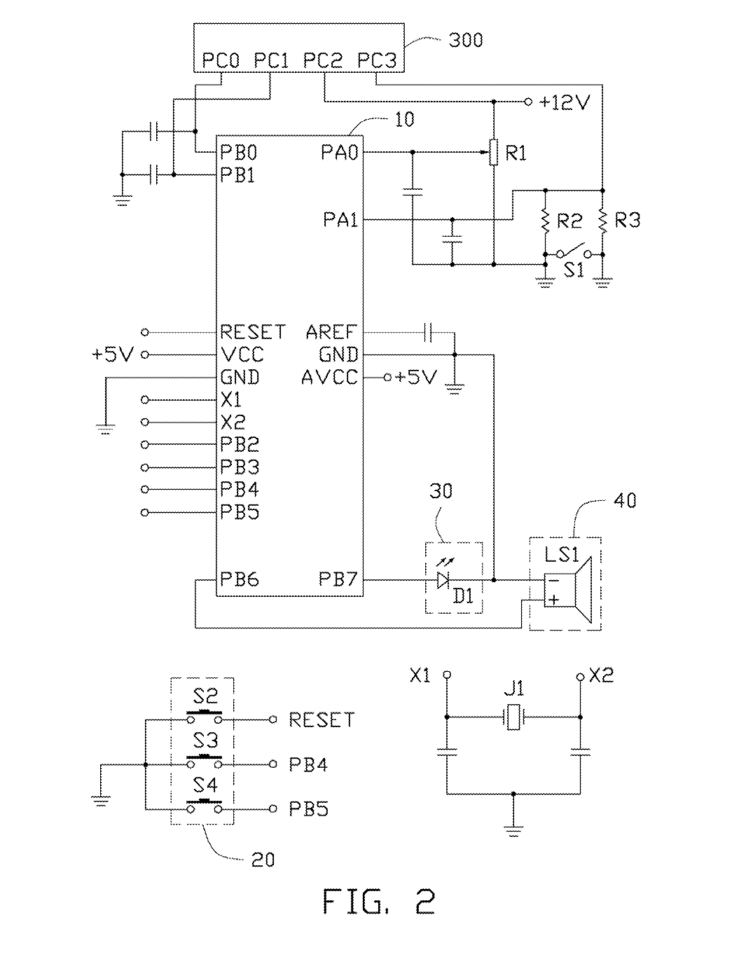

Referring to FIG. 2, the micro controller 10 includes analog input terminals PA0, PA1, eight bits bidirectional I/O terminals PB0˜PB7, a reset terminal RESET, an oscillator signal input terminal X1, an oscillator signal output terminal X2, a power terminal VCC and a ground terminal GND. The analog input terminal PA0 is configured to receive the rotational voltages. The analog input terminal PA1 is configured to receive the rotational currents. The I/O terminal PB0 is configured to output the pulse control signals. The I/O terminal PB1 is configured to receive the rotational speed signals. The I/O terminal PB2 is configured to receive digital signals. The I/O terminal PB3 is configured to transmit digital signals. The I/O terminal PB4 is configured to receive a first switch control signal. The I/O terminal PB5 is configured to receive a second switch control signal. The I/O terminal PB6 is configured to output the indication signal. The I/O terminal PB7 is configured to output an alarm signal.

The indication module 30 includes a LED D1, the alarm module 40 includes a buzzer LS1. A buzzer LS1 anode is electrically connected to the I/O terminal PB6. A LED D1 anode is electrically connected to the I/O terminal PB7. A buzzer LS1 cathode and a LED D1 cathode are grounded. The fan 300 includes a pulse control signal input terminal PC0, a rotational speed signal output terminal PC1, a power terminal PC2 and a ground terminal PC3. The I/O terminal PB0 is electrically connected to the pulse control signal input terminal PC0. The rotational speed signal output terminal PC1 is electrically connected to the I/O terminal PB1. A variable resistor R1 grounds the power terminal PC2. The power terminal PC2 is configured to receive a +12V DC voltage. The analog input terminal PA0 is electrically connected to a variable resistor R1 adjusting terminal. The ground terminal PC3 is electrically connected to the analog input terminal PA1. A first resistor R2 grounds the ground terminal PC3. A second resistor R3 grounds the ground terminal PC3 and a toggle switch S1 that are connected in series.

The switch module 20 includes a first push switch S2, a second push switch S3 and a third push switch S4. The first push switch S2 grounds the reset terminal RESET. The second push switch S3 grounds the I/O terminal PB4. The third push switch S4 grounds the I/O terminal PBS. When the first push switch S2 is pushed, the micro controller 10 is initialized. When the second push switch S3 is pushed, the micro controller 10 outputs sequential pulse control signals at the I/O terminal PB0; and when the third push switch S4 is pushed, the micro controller 10 outputs intervallic pulse control signals at the I/O terminal PB0. The crystal oscillator J1 grounds the oscillator signal input terminal X1 and the oscillator signal output terminal X2. The A frequency of the crystal oscillator J1 is 16 MHZ. The crystal oscillator J1 is configured to generate a 24 MHZ pulse control signals at the I/O terminal PB0.

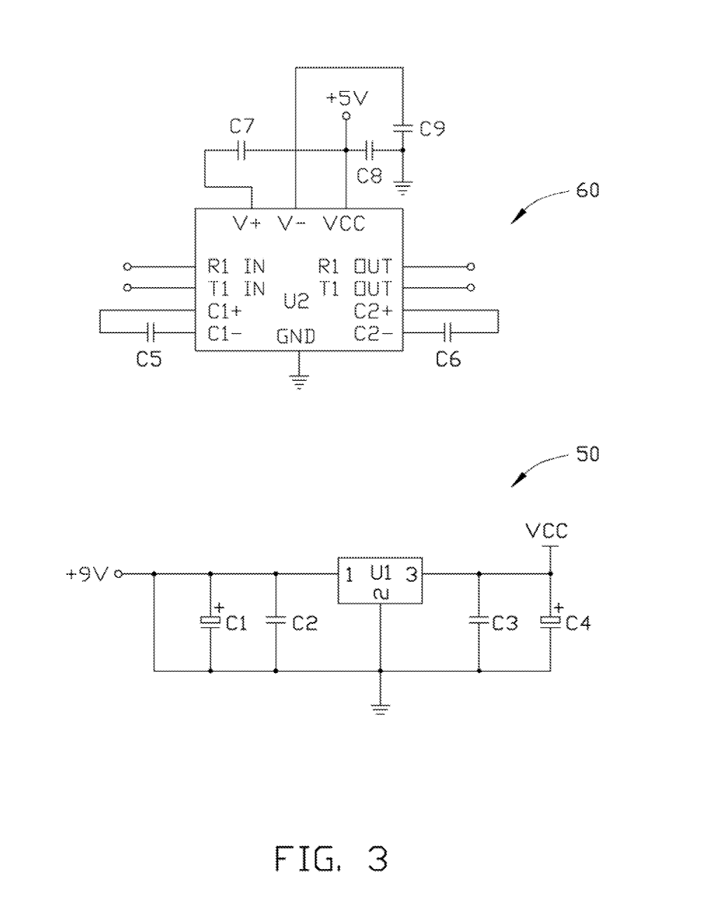

Referring to FIG. 3, the power supply module 50 includes a voltage regulator U1 and capacitors C1˜C4. The voltage regulator U1 includes an input terminal, a ground terminal and an output terminal. The voltage regulator U1 input terminal is electrically connected to a capacitor C1 first terminal and a capacitor C2 first terminal. A capacitor C1 second terminal and a capacitor C2 second terminal are electrically connected to the voltage regulator U1 ground terminal. The voltage regulator U1 output terminal is electrically connected to a capacitor C3 first terminal and a capacitor C4 first terminal. A capacitor C3 second terminal and a capacitor C4 second terminal are electrically connected to the voltage regulator U1 ground terminal. The voltage regulator U1 input terminal is electrically connected to a voltage adapter (not shown). The voltage regulator U1 input terminal provides a +12V DC voltage to the fan 300. The voltage regulator U1 output terminal provides a +5V DC voltage to the micro controller 10 and the conversion module 60. In this embodiment, the voltage adapter (not shown) converts a +220VAC voltage to a +9V DC voltage.

The conversion circuit 60 includes a voltage level conversion chip U2, and capacitors C5˜C9. In one embodiment, the voltage level conversion chip U2 is a MAX232 type chip for RS-232 standard interface circuit of computer. The voltage level conversion chip U2 includes charge terminals C1+, C1−, V+, V−, C2+, C2−, data transforming terminals T1 IN, T1 OUT, R1 IN, R1 OUT, a power terminal VCC, and a ground terminal GND. The charge terminal C1+ is electrically connected to the charge terminal C1− via the capacitor C5. The charge terminal C2+ is electrically connected to the charge port C2− via the capacitor C6. The charge terminal V+ is electrically connected to the +5V DC voltage via the capacitor C7. The charge terminal V− is grounded via the capacitor C9. The charge terminals C1+, C1−, V+, V−, C2+, C2− and capacitors C5, C6, C7, C9 form a charge pump circuit for generating a +12V voltage and a −12V voltage which are provided to the RS-232 standard interface circuit. The voltage level conversion chip U2 power port VCC is electrically connected to the +5V DC voltage. The voltage level conversion chip U2 power port VCC is grounded via the capacitor C8. The data transforming port T1 IN acts as a voltage level signal receiving terminal for receiving the rotational speed signals, rotational voltages and rotational currents from the I/O terminal PB3. The data transforming port T1 OUT acts as a voltage level signal transmitting terminal for transmitting the converted rotational speed signals, rotational voltage signals and rotational current signals to the control device 200. The data transforming port R1 IN acts as a voltage level signal receiving terminal for receiving the test complete signal from the control device 200. The data transforming port R1 OUT acts as a voltage level signal transmitting terminal for transmitting the converted test complete signal to the I/O terminal PB2.

During testing, the fan 300 is electrically connected to the testing system as shown in FIG. 1. The second push switch S3 or the third push switch S4 is pushed to control the I/O terminal PB output sequential pulse control signals or intervallic pulse control signals. The pulse control signal input terminal PC0 receives the pulse control signals. The fan 300 adjusts its rotational speed according to the pulse control signals from the micro controller 10. The pulse control signal output terminal PC1 outputs the rotational speed signals to the micro controller 10. The analog input terminal PA0 collects the rotational voltage signals of the fan 300 under different rotational speeds via the variable resistor R1. The analog input terminal PA1 collects the rotational current signals of the fan 300 under different rotational speeds via the resistors R2, R3. The micro controller 10 determines rotational speeds, rotational voltages, and rotational currents of the fan 300 according to the rotational speed signals, the rotational voltage signals and the rotational current signals. The micro controller 10 outputs the rotational speeds, the rotational voltages and the rotational currents to the control device 200 via the conversion module 60.

The control device 200 stores a plurality of normal rotational voltages and rotational currents value under different rotational speeds. The control device 200 compares the rotational speeds, rotational voltages and rotational currents from the micro controller 10 with the plurality of normal rotational voltage and rotational current values, and outputs the test complete signal or an abnormal signal to the micro controller 10 according to the comparison result. The micro controller 10 outputs the indication signal to the indication module 30 when it receives the test completed signal. The indication module 30 emits light to indicate that the fan 300 is rotating under a normal rotational speed when it receives the indication signal. The micro controller 10 outputs the alarm signal when it receives the abnormal signal. The alarm module 40 makes a sound to indicate that the fan 300 is rotating under an abnormal rotational speed when it receives the alarm signal.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A fan testing system comprising:
a control device configured to store a plurality of normal rotational voltage and rotational current values under different rotational speeds; and
a test control apparatus electrically connected to the control device and a fan, the test control apparatus comprising:
a switch module configured to output switch control signals; and
a micro controller configured to receive the switch control signals and output pulse control signals to the fan; wherein the fan is configured to adjust its rotational speed according to the pulse control signals and output rotational speed signals to the micro controller; the micro controller is configured to collect rotational voltage signals and rotational current signals of the fan under different rotational speeds, and determine rotational speeds, rotational voltages and rotational currents of the fan;
wherein the control device is configured to compare the rotational speeds, rotational voltages and rotational currents of the fan from the micro controller with the plurality of normal rotational voltage and rotational current values under different rotational speeds, and output a test complete signal to the micro controller when the fan rotates under the plurality of normal rotational voltage and rotational current values.

2. The fan testing system of claim 1, wherein the test control apparatus further comprises an indication module; the micro controller is configured to output an indication signal when receives the test complete signal; and the indication module is configured to emit light to indicate the fan rotates under the plurality of normal rotational voltage and rotational current values when the indication module receives the indication signal.

3. The fan testing system of claim 1, wherein the test control apparatus further comprises an alarm module; the control device is configured to output an abnormal signal to the micro controller when the fan does not rotate under the normal rotational voltage and rotational current values; the micro controller is configured to output an alarm signal when the abnormal signal is received; and the alarm module is configured to make a sound to indicate the fan does not rotate under the normal rotational voltage and rotational current values when the alarm module receives the alarm signal.

4. The fan testing system of claim 3, wherein the test control apparatus further comprises a power supply module for providing DC voltages to the micro controller, the switch module, and the alarm module.

5. The fan testing system of claim 1, wherein the test control apparatus further comprises a conversion module configured to convert the rotational speed signals, the rotational voltage signals and the rotational current signals to which is identified by the control device; and the micro controller is configured to transmit the rotational speed signals, the rotational voltage signals and the rotational current signals converted by the conversion module to the control device via the conversion module.

6. The fan testing system of claim 1, wherein the micro controller comprises a pulse control signal output terminal, a rotational speed signal input terminal, a voltage signal collecting terminal and a current signal collecting terminal; the fan comprises a pulse control signal input terminal, a rotational speed signal output terminal, a power terminal and a ground terminal; the pulse control signal input terminal is electrically connected to the pulse control signal output terminal for receiving the pulse control signals; the rotational speed signal input terminal is electrically connected to the rotational speed signal output terminal for receiving the rotational speed signals; the power terminal is grounded via a variable resistor; the voltage signal collecting terminal is electrically connected to a variable resistor adjusting terminal; the ground terminal is electrically connected to the current signal collecting terminal; and the ground terminal is grounded via a first resistor.

7. The fan testing system of claim 6, wherein the ground terminal is grounded via a second resistor and a toggle switch that are connected in series.

8. The fan testing system of claim 6, wherein the micro controller further comprises a reset terminal, a first switch control signal input terminal and a second switch control signal input terminal; the switch module comprises a first push switch, a second push switch and a third push switch; the reset terminal is grounded via the first push switch; the first switch control signal input terminal is grounded via the second push switch; and the second switch control signal input terminal is grounded via the third push switch.

9. The fan testing system of claim 8, wherein when the first push switch is pushed, the micro controller is initialized; when the second push switch is pushed, the micro controller outputs sequential pulse control signals at the pulse control signal output terminal; and when the third push switch is pushed, the micro controller outputs intervallic pulse control signals at the pulse control signal output terminal.

10. A fan testing system comprising:
a control device configured to store a plurality of normal rotational voltage and rotational current values under different rotational speeds; and
a micro controller configured to output pulse control signals to a fan; wherein the fan is configured to adjust its rotational speed according to the pulse control signals, and output rotational speed signals to the micro controller; the micro controller is configured to collect rotational voltage signals and rotational current signals of the fan under different rotational speeds, and determine rotational speeds, rotational voltages, and rotational currents of the fan;
wherein the control device is configured to compare the rotational speeds, rotational voltages and rotational currents from the micro controller with the plurality of normal rotational voltage and rotational current values, and output a test complete signal to the micro controller when the fan rotates under the plurality of normal rotational voltage and rotational current values.

11. The fan testing system of claim 10, further comprising an indication module; the micro controller is configured to output an indication signal to the indication module when receives the test complete signal; and the indication module is configured to emit light to indicate the fan rotates under the plurality of normal rotational voltage and rotational current values when the indication module receives the indication signal.

12. The fan testing system of claim 10, further comprising an alarm module; the control device is configured to output an abnormal signal to the micro controller when the fan does not rotate under the normal rotational voltage and rotational current values; the micro controller is configured to output an alarm signal when the abnormal signal is received; and the alarm module is configured to make a sound to indicate the fan does not rotate under the normal rotational voltage and rotational current values when the alarm module receives the alarm signal.

13. The fan testing system of claim 12, further comprising a power supply module for providing DC voltages to the micro controller, the switch module, and the alarm module.

14. The fan testing system of claim 10, further comprising a conversion module configured to convert the rotational speed signals, the rotational voltage signals and the rotational current signals to which is identified by the control device; and the micro controller is configured to transmit the rotational speed signals, the rotational voltage signals, and the rotational current signals converted by the conversion module to the control device via the conversion module.

15. The fan testing system of claim 10, wherein the micro controller comprises a pulse control signal output terminal, a rotational speed signal input terminal, a voltage signal collecting terminal, and a current signal collecting terminal; the fan comprises a pulse control signal input terminal, a rotational speed signal output terminal, a power terminal, and a ground terminal; the pulse control signal input terminal is electrically connected to the pulse control signal output terminal for receiving the pulse control signals; the rotational speed signal input terminal is electrically connected to the rotational speed signal output terminal for receiving the rotational speed signals; the power terminal is grounded via a variable resistor; the voltage signal collecting terminal is electrically connected to a variable resistor adjusting terminal; the ground terminal is electrically connected to the current signal collecting terminal; and the ground terminal is grounded via a first resistor.

16. The fan testing system of claim 15, wherein the ground terminal is grounded via a second resistor and a toggle switch that are connected in series.

17. The fan testing system of claim 15, wherein the micro controller further comprises a reset terminal, a first switch control signal input terminal and a second switch control signal input terminal; the switch module comprises a first push switch, a second push switch and a third push switch; the reset terminal is grounded via the first push switch; the first switch control signal input terminal is grounded via the second push switch; and the second switch control signal input terminal is grounded via the third push switch.

18. The fan testing system of claim 17, wherein when the first push switch is pushed, the micro controller is initialized; when the second push switch is pushed, the micro controller outputs sequential pulse control signals at the pulse control signal output terminal; and when the third push switch is pushed, the micro controller outputs intervallic pulse control signals at the pulse control signal output terminal.
